(19) United States
(12) Patent Application Publication
(10) Pub. No.: US 2004/0113915 A1
(43) Pub. Date: Jun. 17, 2004

(54) Mobile terminal device and image display method

(76) Inventors: Toshikazu Ohtsuki, Osaka-shi (JP); Katsunori Orimoto, Neyagawa-shi (JP); Yoshiyuki Mochizuki, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/729,976

(22) Filed: Dec. 9, 2003

(30) Foreign Application Priority Data
Dec. 16, 2002 (JP) 2002-363636

(51) Int. Cl. G09G 5/00

(52) U.S. Cl. 345/582

(57) ABSTRACT

A mobile terminal device, which is capable of displaying personal information, time information, and group information in a manner that enables a user to easily understand the relationship among such information, as well as capable of displaying such information in a manner that clarifies their relationship by seamlessly moving viewpoint positions, comprises: an object unit 100a for generating and storing various objects making up a 3D object; a database unit 100b for storing information displayed on the 3D object; a mode unit 100c for selecting a display mode shown on the screen; a cursor unit 100d for performing input processing of the cursor key; a decision key unit 100e used by the user when selecting desired information from plural pieces of displayed information; a viewpoint unit 100f for moving the viewpoint according to a user input; a rendering unit 100g for rendering various objects based on their position information; and a display unit 100h for generating and displaying an image to be shown on the mobile terminal device.

### BACKGROUND OF THE INVENTION

(1) Field of the Invention

The present invention relates to a mobile terminal device such as a mobile phone and a PDA that displays various information such as personal information, and particularly to a mobile terminal device that displays various information on a small screen.

(2) Description of the Related Art

Existing mobile terminal devices such as PDAs and mobile phones are capable of managing many kinds of personal information such as address book, call memory and history of sending/receiving mails. Such information is displayed on the screen of a mobile phone according to a user operation.

In order to display desired information on the screen of an existing mobile terminal device, the user is required to select such desired information from among plural pieces of information displayed on the screen and switch between display screens for more than one time. For this reason, existing mobile terminal devices are designed to improve the convenience of users such as by displaying each of various information on the screen as a different icon and in a different color.

Meanwhile, as an existing screen display method for personal computers (PCs), there are techniques for displaying an image in a 3D image space instead of a 2D image space. One of such techniques is embodied as an information display apparatus and a method thereof utilizing a 3D icon (see Japanese Laid-Open Patent application No.07-84746). In such existing information display apparatus and method, when information is displayed on the screen of a PC using icons and windows, a display screen including icons is shown in 3D, and another screen is displayed by moving the image displayed on the display screen in a three dimensional manner according to a movement of the viewpoint caused by a user operation. This prevents the situation in which the user cannot see information properly due to overlapping windows, as well as making it easier for the user to distinguish the relationship between icons and windows. For example, by moving the viewpoint to the ceiling position, the user can see the windows and icons viewed from the direction of the ceiling. Accordingly, it becomes easier to visualize the relationship between the windows.

However, since such existing information display apparatus and method utilizing 3D icons and windows are capable only of changing positions of the viewpoint, they cannot represent the relationship among various information displayed on the screen such as windows and icons.

Furthermore, since recent mobile terminal devices are increasingly equipped with multiple functionalities, information and functionalities have been more and more hierarchized. As a result, information to be selected by the user tends to be more complicated, causing another problem that it becomes difficult for such user to find desired information and functionality.

Moreover, since the screen of a small-sized mobile terminal device such as a mobile phone cannot display more than one piece of information all at once as a PC and the like can do, it is impossible for the user to know the relationship between each piece of displayed information or judge the temporal flow of and connection between such information. Thus, it is difficult for the user to get a good grasp of complicated and wide-ranging information.

### SUMMARY OF THE INVENTION

The present invention has been conceived in view of the above problems, and it is an object of the present invention to provide a mobile terminal device capable of displaying an increased amount of information in a visually distinctive manner even when the display screen of a mobile terminal device is small, so as to improve the convenience of the user at the time of making a selection from among such information.

Another object of the present invention is to provide a mobile terminal device capable of displaying plural pieces of information on the screen in a manner in which the user can easily distinguish the connection between one information from the other, in order to enable such user to find required information without needing to switch between screens when narrowing down information.

In order to solve the above problems, the mobile terminal device according to the present invention is a mobile terminal device that has a database storing a first information list, a second information list and a third information list, comprising: a scene generation unit operable to generate a 3D object on which the first information list is associated with a direction of a first axis, the second information list is associated with a direction of a second axis, and the third information list is associated with a direction of a third axis, the first to third axes being in a 3D xyz space, the second information list relating to the first information list, and the third information list relating to either the first information list or the second information list; and a display unit operable to display the generated 3D object on a screen of the mobile terminal device.

Furthermore, the mobile terminal device according to the present invention further comprises: a viewpoint moving unit operable to move a viewpoint freely according to an input from a user of the mobile terminal device; and an image generation unit operable to generate an image of the 3D object generated by the scene generation unit, the image being viewed from the moved viewpoint, and in said mobile terminal device, the display unit displays the 3D object on the screen of the mobile terminal device according to the image generated by the image generation unit.

Moreover, the mobile terminal device according to the present invention further comprises: a texture generation unit operable to generate 2D texture images showing items listed on each of the lists stored in the database; a model generation unit operable to generate polygon models having 2D or 3D space coordinates; and an object generation unit operable to generate small objects by mapping each of the generated texture images on a surface of or inside each of the polygon models, and in said mobile terminal device, the scene generation unit generates the 3D object by laying said small objects on one another in the 3D xyz space.

Also, the mobile terminal device according to the present invention further comprises a mode selection unit operable to select one of a plurality of display modes for displaying an image of the 3D object viewed from the viewpoint in the 3D xyz space, and in said mobile terminal device, the display unit displays the 3D object on the screen according to the display mode which the mode selection unit selects based on an instruction from the user.

Note that not only is it possible to embody the present invention as a mobile terminal device with the above configuration but also as an image display method that includes, as its steps, characteristic units of such mobile terminal device, and as a program that causes a computer to execute such method. It should be also understood that such program can be distributed via a recording medium such as a CD-ROM and via a transmission medium such as a network.

With the above configuration, the mobile terminal device according to the preset invention is capable of displaying an increased amount of information all at once by displaying, on the screen, a 3D object made up of various objects showing personal information and history information, as well as capable of clarifying the relationship between plural pieces of information even on the small screen. Accordingly, the present invention will provide mobile terminal devices capable of improving the user convenience when selecting information.

Furthermore, since plural pieces of information are placed in a manner that allows the user to grasp the relationship among such pieces of information more easily, it becomes possible to distinctly display a chronological relationship between personal information and history information on the 3D object. Accordingly, the present invention will provide mobile terminal devices capable of displaying images that take into account the convenience of the users.

For further information about the technical background to this application, Japanese Patent application No. 2002-363636 filed on Dec. 16, 2002 is incorporated herein by reference.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an example functional configuration of a mobile terminal device according to the present embodiment;

FIG. 2 is a flowchart showing a procedure followed by a user of the mobile terminal device when selecting a display mode via a mode selection unit;

FIG. 3 is a flowchart showing a procedure followed by the user of the mobile terminal device when changing display modes via a viewpoint moving unit;

FIG. 4 is a diagram showing an example of normal display mode displayed on a screen of the mobile terminal device;

FIG. 5 is a diagram showing an example of a personal name ID data table, generated by an information management unit, in which personal name IDs are classified on a group ID basis;

FIG. 6 is a diagram showing an example of a position information table showing coordinates of personal information objects and group information objects in normal display mode;

FIG. 7 is a flowchart showing a procedure of displaying a display mode when normal display mode is selected;

FIG. 8 is a diagram showing an example of oblique display mode displayed on the screen, when the user selects oblique display mode;

FIG. 9 is a diagram showing an example of oblique display mode displayed on the screen of the mobile terminal device, when the user selects oblique display mode;

FIG. 10 is a diagram showing an example of a history ID data table, generated by the information management unit, in which history IDs are classified for on a personal name ID basis;

FIG. 11 is a diagram showing an example of a position information table which shows the position of personal information objects, group information objects, and history information objects;

FIG. 12 is a flowchart showing a procedure of displaying a display mode when oblique display mode is selected;

FIG. 13A is a diagram showing an example of personal information display mode;

FIG. 13B is a diagram showing a 3D object viewed from the top;

FIG. 14 is a flowchart showing a procedure of displaying a display mode when personal information display mode is selected;

FIG. 15 is a diagram showing an example of a selection screen shown on the screen of the mobile terminal device before the user selects immersive information display mode;

FIG. 16 is a diagram showing a display example of immersive information display mode to be displayed when the user selects one of personal information objects in the selection screen shown before immersive information display mode is selected, as well as showing a display example when a viewpoint moves inside history information objects in x, y, and z directions;

FIG. 17 is a flowchart showing a procedure of displaying a display mode when immersive information display mode is selected;

FIG. 18 is a diagram explaining a difference between respective viewpoint positions in oblique display mode and immersive information display mode;

FIG. 19 is a reference diagram visualizing changes between normal display mode, oblique display mode, immersive information display mode, and personal information display mode, which are four display modes to be shown on the screen of the mobile terminal device according to the present invention; and

FIG. 20 is a reference diagram visualizing changes between is normal display mode, oblique display mode, immersive information display mode, and personal information display mode, which are four display modes to be shown on the screen of the mobile terminal device according to the present invention.

### DESCRIPTION OF THE PREFERRED EMBODIMENT

The following gives an explanation of a mobile terminal device according to the preferred embodiment of the present invention with reference to the figures. An example of the mobile terminal device according to the present embodiment is a mobile phone and a PDA capable of sending/receiving information to and from another individual via a wireless network and equipped with a small-sized screen for displaying information in response to a user request. Note that an explanation is given here for the case where information to be displayed on the screen of the mobile terminal device according to the present embodiment is personal information, group information and history information. However, the present invention is not limited to these types of information and therefore that the mobile terminal device according to the present invention can also display another type of information such as pictures taken by a camera equipped to the mobile terminal device.

The personal information is made up of personal information elements about the user and individuals who send/receive information to and from such user. Each of the personal information elements is a personal ID, a group ID, a name, an e-mail address, a telephone number, an address, a memo, and the like.

The group information can be user-defined groups and default groups. Examples of user-defined groups are a group of people in the same work place as the user's, a group of people belonging to the same circle of a hobby, and the like. Meanwhile, examples of default groups are groups classified in alphabetical order. The group information in the present invention is made up of group IDs and group names.

The history information is information which is related to processes performed by the user of the mobile terminal device (to be also referred to simply as “the user” hereinafter). For example, the history information includes the following information: history IDs which are identifiers assigned to the times at which telephone and mail processes are performed; process IDs which are identifiers assigned to sending/receiving of mails and telephone calls which are the details of the processes; personal IDs which are identifiers of persons who performed processes or for whom the user performed processes; and the times at which the processes were performed.

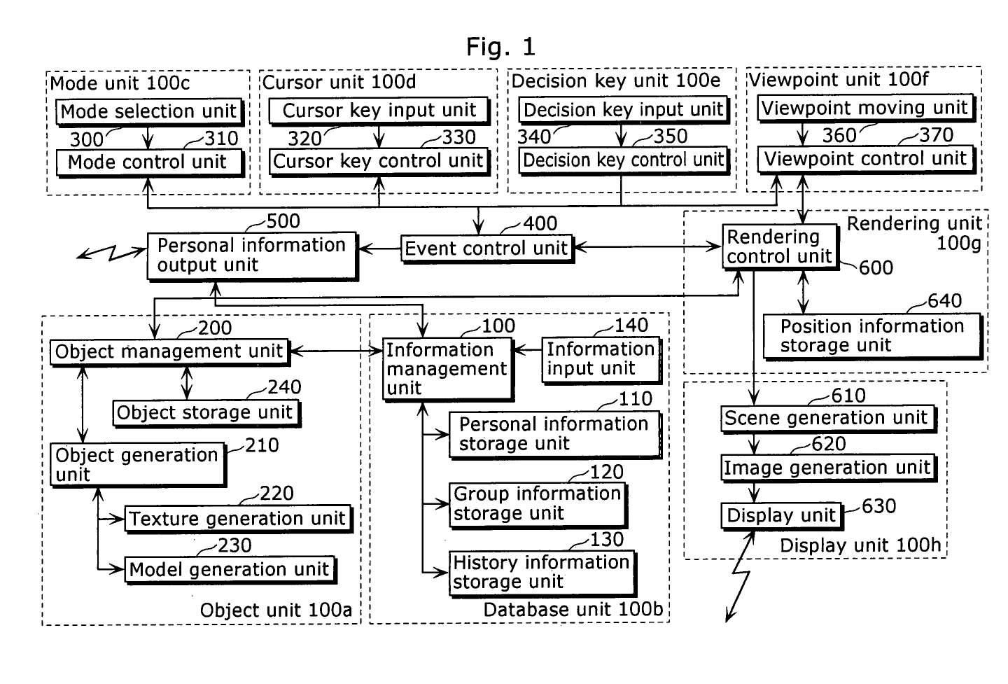

FIG. 1 is a block diagram showing an example functional configuration of the mobile terminal device according to the present embodiment.

An object unit 100a shown in FIG. 1 is a management unit for generating and storing various objects making up a 3D object, and is comprised of an object management unit 200, an object generation unit 210, a texture generation unit 220, a model generation unit 230, and an object storage unit 240.

The texture generation unit 220 combines, with font image data which it holds in itself in advance, a group name and a personal name and the like passed from a data table of the object management unit 200 via the object generation unit 210, so as to generate texture images including text.

The model generation unit 230 generates an object model onto which the above texture image will be mapped, in response to an instruction from the object generation unit 210. A 3D object to be displayed on the screen is generated by laying object models one another in a 3D space. An example of an object model is a polygon model having 3D coordinates. A detailed explanation of a polygon model is given later.

The object generation unit 210 generates a 3D object including information such as personal information by mapping the texture image generated by the texture generation unit 220 on the object model generated by the model generation unit 230. 3D image information is generated by laying more than one 3D object on each other.

The object storage unit 240 stores the 3D object generated by the object generation unit 210, at the instruction from the object management unit 200.

The object management unit 200 instructs the object generation unit 210 to generate various objects required to generate a scene at the instruction from a rendering control unit 600, and requests the information management unit 100 to generate data tables for personal information, group information and history information.

Note that in the present invention, six types of objects are used: personal information object, group information object, history information object, cursor object, history information caption object, and personal information element object.

Each personal information object is made up of a 2D texture image showing personal information (e.g. personal name and telephone number) and a polygon model having 3D coordinates used to place and render such texture image in the 3D space.

Each group information object is made up of a 2D texture image showing group information (e.g. circle and office) and a polygon model having 2D coordinates used to place and render such texture image in the 2D space. Note that this group information object may be a 3D model.

Each history information object is made up of a 2D texture image showing history information (e.g. sending/receiving of mails) and a polygon model having 3D coordinates used to place and render such texture image in the 3D space.

The cursor object, for example, is an arrow and the like to be displayed on the screen for the user when making a selection from among various objects. Each history information caption object indicates the details of a history information object.

Each personal information element object becomes a 2D texture image including text, when an e-mail address, a telephone number, an address, or a memo included in the personal information is combined with font image data. Note that this group information object may be a 3D model.

A database unit 100b shown in FIG. 1 is a storage unit for storing information displayed on the 3D objects, and is comprised of the information management unit 100, a personal information storage unit 110, a group information storage unit 120, a history information storage unit 130, and an information input unit 140.

The personal information storage unit 110 stores, in table form, personal information such as a personal name, a telephone number, and an e-mail address, as well as personal IDs and group IDs. The information management unit 100 assigns, to each personal information, a group ID of a group each person belongs to as well as a personal ID to be classified on a group-by-group basis, at the time of inputting such personal information.

The group information storage unit 120 stores group information defined by the user as well as default group information. The information management unit 100 assigns a group ID to each of the group information at the time of inputting the information.

The history information storage unit 130 stores history information which is each person's communication history indicating the making/receiving of phone calls and the sending/receiving of mails. The information management unit 100 assigns a history ID to each history information in order of the times at which the above telephone and mail processes are performed, at the time of inputting such history information. A personal ID and a process ID are also assigned to each history information.

The information input unit 140, which is operation buttons and the like equipped to the mobile terminal device, is used to update the personal information, the group information, and the history information stored in the database unit 100b when there is new information directly entered by the user. Such newly entered personal information, group information and history information are passed respectively to the personal information storage unit 110, the group information storage unit 120 and the history information storage unit 130 via the information management unit 100.

The information management unit 100 manages the information stored in the personal information storage unit 110, the group information storage unit 120 and the history information storage unit 130 respectively as personal IDs, group IDs, and history IDs. The information management unit 100 generates data tables that show the information stored in each of the above storage units 110, 120, and 130 at the instruction of the object management unit 200, and passes the generated data tables to the object management unit 200.

A mode unit 100c shown in FIG. 1 is a processing unit for selecting a display mode to be shown on the screen of the mobile terminal device, and is comprised of a mode selection unit 300 and a mode control unit 310.

The mode selection unit 300 is an input unit used by the user to select normal display mode and oblique display mode, and the like. The mode control unit 310 notifies the event control unit 400 of the display mode selected by the mode selection unit 300.

The cursor unit 100d shown in FIG. 1 is a processing unit for performing input processing of the cursor key equipped to the mobile terminal device, and is comprised of a cursor key input unit 320 and a cursor key control unit 330.

The cursor key input unit 320 is an operation button generally known as an arrow key which is equipped to the mobile terminal device, and is operated in four directions of up, down, right, and left. The cursor key control unit 330 notifies the event control unit 400 of a control over a position of the cursor on the screen. This control is caused by a user input made on the cursor key input unit 320.

Here, an explanation is given of a method of determining coordinates at which the cursor object is placed. The cursor key input unit 320 sends a key code to the cursor control unit 330, according to an input from the user. A key code is an identifier for each key corresponding to the respective directions of up, down, right and left.

The cursor control unit 330 notifies the event control unit 400 of which key code has been inputted. In the present invention, since the cursor moves in a different direction in the 3D space depending on the direction of a key code, the event control unit 400 stores, in advance, a data table showing a correspondence relationship between the respective display modes set by the mode control unit 310, and cursor directions (up, down, right and left) and directions in the 3D space. The event control unit 400 passes, to the rendering control unit 600, a direction in which the cursor shall be moved in the 3D space, according to this data table. For example, in the case of normal display mode, the respective directions of the cursor of up, down, right and left indicate the movements in directions of the negative y axis, positive y axis, negative x axis, and positive x axis, respectively.

Here, an explanation is given of a method of placing the cursor object. First, the rendering control unit 600 judges which object is selected according to the position information of an object stored in a position information storage unit 640 and the direction in which the cursor has been moved, and then passes the ID of the object selected by the cursor to a scene generation unit 610. Subsequently, the scene generation unit 610 determines the coordinates of the cursor from the coordinates of the selected object, and places the cursor object.

A decision key unit 100e is an input unit used by the user when selecting one piece of information from plural pieces of displayed information, and is comprised of a decision key input unit 340 and a decision key control unit 350.

The decision key input unit 340 is an operation button and the like equipped to the mobile terminal device to be used by the user when selecting an object with required information from among plural objects. The decision key control unit 350 passes a status of the decision key to the event control unit 400, according to a key code of the decision key inputted via the decision key input unit 340. For example, when the user selects certain personal information via the decision key input unit 340, the event control unit 400 passes such selected personal information to the personal information output unit 500.

A viewpoint unit 100f is an input unit for moving the viewpoint according to a user input, and is comprised of a viewpoint moving unit 360 and a viewpoint control unit 370.

The viewpoint moving unit 360 is operation buttons made up of the following nine key input units used by the user to zoom, scroll and rotate an image displayed on the screen so as to move the viewpoint from which an object displayed on the screen is viewed: a zoom-up key, a zoom-down key, an up-scroll key, a down-scroll key, a right-scroll key, a left-scroll key, an x axis rotation key, a y axis rotation key, and a z axis rotation key.

The viewpoint control unit 370 determines the coordinates of the viewpoint by receiving, from the viewpoint moving unit 360, a key code which is an identifier corresponding to each of the nine keys, and passes the determined viewpoint coordinates to the scene generation unit 610 via the rendering control unit 600. The viewpoint control unit 370 also notifies the event control unit 400 that the viewpoint has been moved.

A rendering unit 100g is a processing unit for rendering an object passed by the object management unit 200 based on its position information, and is comprised of the rendering control unit 600 and the position information storage unit 640.

The rendering unit 600 receives an instruction about a display mode from the event control unit 400. Then, the rendering unit 600 gives an instruction to the object management unit 200 to generate objects required for the selected display mode, and receives the generated objects from the object management unit 200. Moreover, upon the receipt of an instruction to move the viewpoint (e.g. zoom-up, zoom-down) from the viewpoint control unit 370, the rendering unit 600 gives an instruction to the scene generation unit 610 to generate an image that reflects the movement of the viewpoint.

The position information storage unit 640 is a database unit that stores the position coordinates of each object in the 3D space passed from the rendering control unit 600. The position information storage unit 640 passes the position coordinates of each object to the rendering control unit 600 at the time of rendering an image.

A display unit 100h is a processing unit for generating and displaying an image to be shown on the screen of the mobile terminal device, and is comprised of the scene generation unit 610, an image generation unit 620, and a display unit 630.

Under the instruction from the rendering control unit 600, the scene generation unit 610 places the generated 3D objects in the 3D space according to the position information of each of such objects stored in the position information storage unit 640.

After the scene generation unit 610 finishes placing all the objects, the image generation unit 620 calculates how the 3D image looks from the viewpoint coordinates selected by the user via the viewpoint moving unit 360, and outputs the resultant to the display unit 630 as image information. When normal display mode is selected, for example, the rendering control unit 600 sets the viewpoint to the default viewpoint position which corresponds to the respective display modes stored in the position information storage unit 640.

The display unit 630 performs processing for displaying the image generated by the image generation unit 620 on the screen of the mobile terminal device.

The event control unit 400 gives and receives instructions to and from the mode control unit 310 and other control units, in order to switch to another display mode requested by the user, for example.

The personal information output unit 500, which is a processing unit for outputting personal information to devices equipped to the mobile terminal device, outputs personal information to such devices according to an instruction about mail sending and the like sent from the event control unit 400. Some examples of the devices are a mail creation device for creating a mail to be sent to an e-mail address in the personal information, a telephone call device for making a call to a telephone number in the personal information, and an edition device for editing an address and a memo in the personal information, and the like.

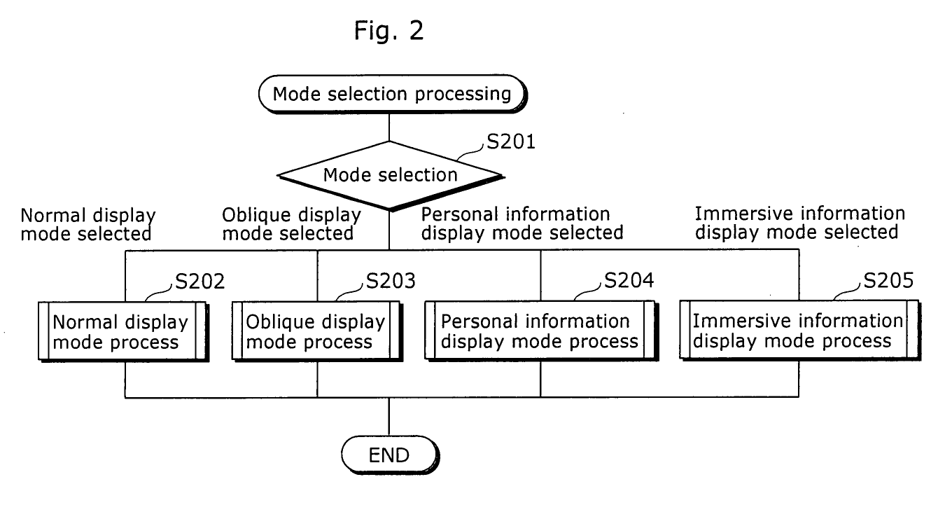

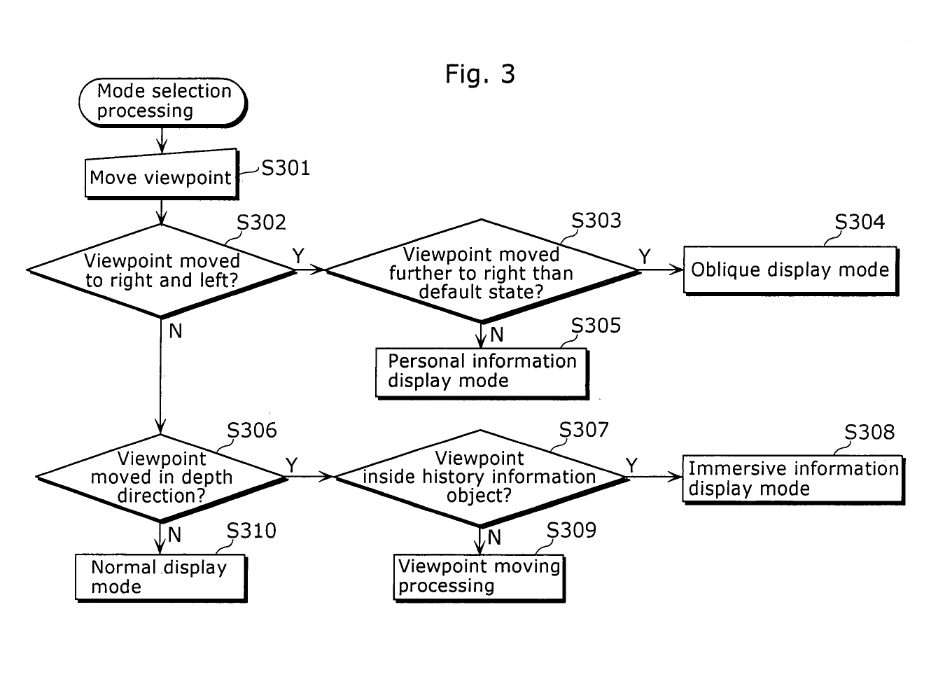

FIG. 2 is a flowchart showing the procedure followed by the user when selecting a display mode via the mode selection unit 300. Note that in the present invention, there are two methods of selecting a display mode: a method shown in FIG. 2 using the mode selection unit 300 and a method shown in FIG. 3 using the viewpoint moving unit 360. Thus, the event control unit 400 determines a display mode selected by the mode control unit 310 and a display mode selected by the viewpoint moving unit 360.

In FIG. 2, the user selects, using the mode selection unit 300, one display mode from key information inputted via a mode key out of four mode keys, each of which corresponds to a key input and a display mode (S201). In the present invention, there are four display modes: normal display mode, oblique display mode, personal information display mode, and immersive information display mode. A detailed explanation of each display mode is given later.

The event control unit 400 performs the normal display mode process when normal display mode is selected by the user (S202), the oblique display mode process when oblique display mode is selected (S203), the personal information display mode process when personal information display mode is selected (S204), and the immersive information display mode process when immersive information display mode is selected (S205).

FIG. 3 is a flowchart showing the procedure followed by the user when changing display modes via the viewpoint moving unit 360. Note that an explanation is given of this flowchart on the assumption that normal display mode is selected as the default screen display mode setting, but another display mode may be used as the default screen display mode setting, depending on a user selection.

The user can move an object on the screen in accordance with a movement of the viewpoint, by performing a key input process via the viewpoint moving unit 360 to move the viewpoint in a three dimensional manner in directions of up, down, right, left, and depth (S301). In the present invention, the event control unit 400 judges whether the viewpoint has moved toward right and left as a result of the user's input process from the viewpoint moving unit 360 (S302). When the viewpoint has been moved toward right and left, the event control unit 400 further judges whether the viewpoint has moved further to the right than the default state (S303). When the viewpoint has been moved toward right, oblique display mode shall be selected as a display mode (S304). Meanwhile, when the viewpoint has not been moved toward right, it indicates that the viewpoint has been moved toward left. Therefore, personal information display mode is selected as a display mode (S305).

When judging in step S302 that the viewpoint has not been moved toward right or left, the event control unit 400 judges whether or not the viewpoint has been moved in the depth direction (S306). When judging that the viewpoint has been moved in the depth direction, the event control unit 400 judges whether the viewpoint is inside any history information object or not (S307), and immersive information display mode is selected as a display mode when the viewpoint is inside a history information object (S308). Meanwhile, when judging that the viewpoint is not inside a history information object, the event control unit 400 simply performs processing for moving the viewpoint (S309).

When the event control unit 400 judges in step S306 that the viewpoint has not been moved in the depth direction, it indicates that the viewpoint has not been moved. Therefore, normal display mode, which is the default display mode, continues to be used as a display mode (S310).

In this display mode switching method utilizing the viewpoint moving unit 360, a display mode can be automatically switched to another one when a position of the viewpoint goes beyond a certain threshold as a result of the user moving the viewpoint via the viewpoint moving unit 360. An example of this threshold is the default viewpoint position of the respective display modes. For example, in the oblique display mode, when the viewpoint goes beyond the initial viewpoint position of the oblique viewpoint display mode as a result of moving the viewpoint toward left, the mode shall be automatically switched to personal information display mode. As described above, it is possible to facilitate the user operation by allowing a display mode to be automatically switched to another one.

The following gives explanations of normal display mode, oblique display mode, immersive information display mode, and personal information display mode in order of appearance.

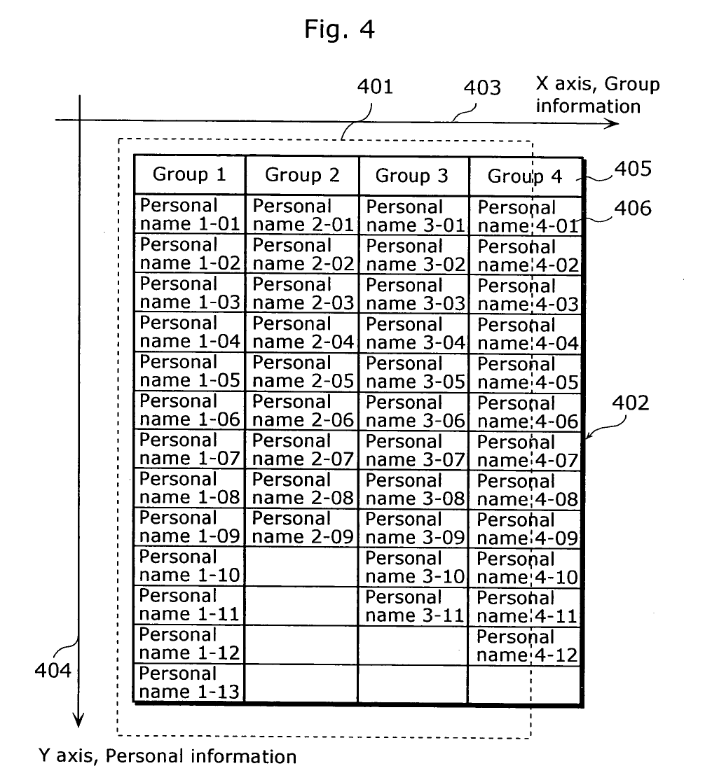

First, normal display mode is explained. FIG. 4 is a diagram showing an example of normal display mode displayed on a screen 401 of the mobile terminal device.

This normal display mode is intended for displaying an object 402 displayed as a 2D image. In this mode, group information objects 405 are individually displayed in the direction of an x axis 403, and personal information objects 406, which are personal names of persons belonging to such groups, are displayed in the direction of a y axis 404.

For example, the left-most column in FIG. 4 indicates that persons with Personal name 1-01, Personal name 1-02, Personal name 1-03, Personal name 1-04, . . . , belong to Group 1.

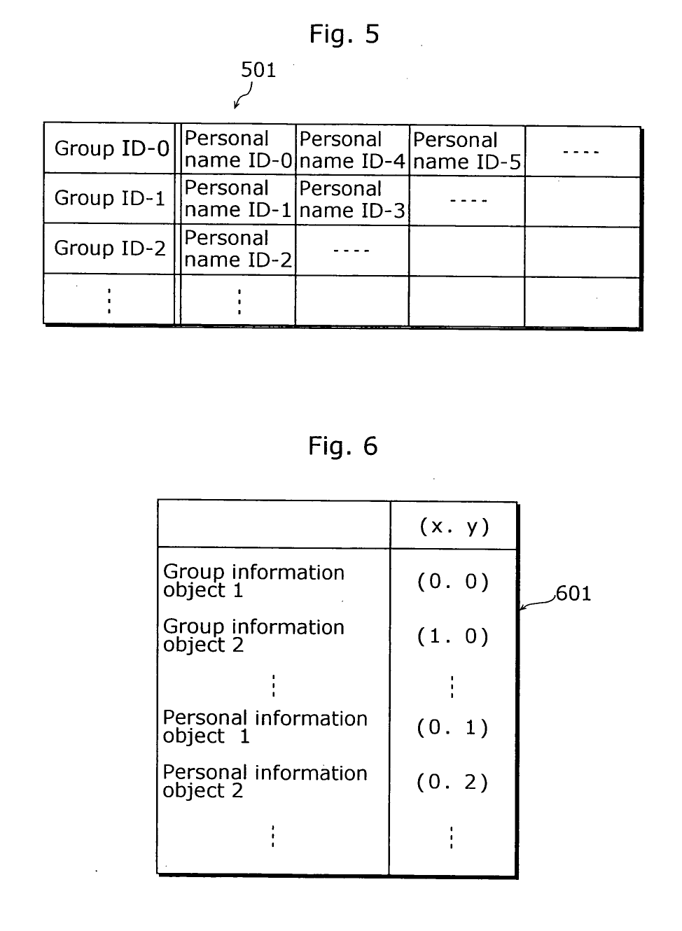

FIG. 5 is a diagram showing an example of a personal name ID data table 501, generated by the information management unit 100, in which personal name IDs are classified on a group ID basis.

Upon the receipt of a request for a data table showing personal information and group information from the object management unit 200, the information management unit 100 generates the data table 501 that shows personal name IDs for each group ID, with reference to personal name IDs and group IDs which it manages, as well as the personal information and the group information respectively stored in the personal information storage unit 110 and the group information storage unit 120.

For example, the first row in FIG. 5 indicates that persons with Personal name ID-0, Personal name ID-4, Personal name ID-5, . . . , belong to Group ID-0.

FIG. 6 is a diagram showing an example of a position information table 601 showing the coordinates of personal information objects and group information objects in normal display mode.

Since normal display mode shows a 2D image on the screen, the position of each object in the 2D space is determined when each object's position information in the directions of x axis and y axis are determined. Note that the x axis and y axis directions are directions indicated by 403 and 404 in FIG. 4.

For example, the fist row in the position information table 601 indicates that the position information of Group information object 1 is (0, 0).

Next, an explanation is given of the operation at the time of normal display mode. Note that in normal display mode according to the present embodiment, group information objects and personal information objects are assumed to be displayed on the screen of the mobile terminal device as the default setting.

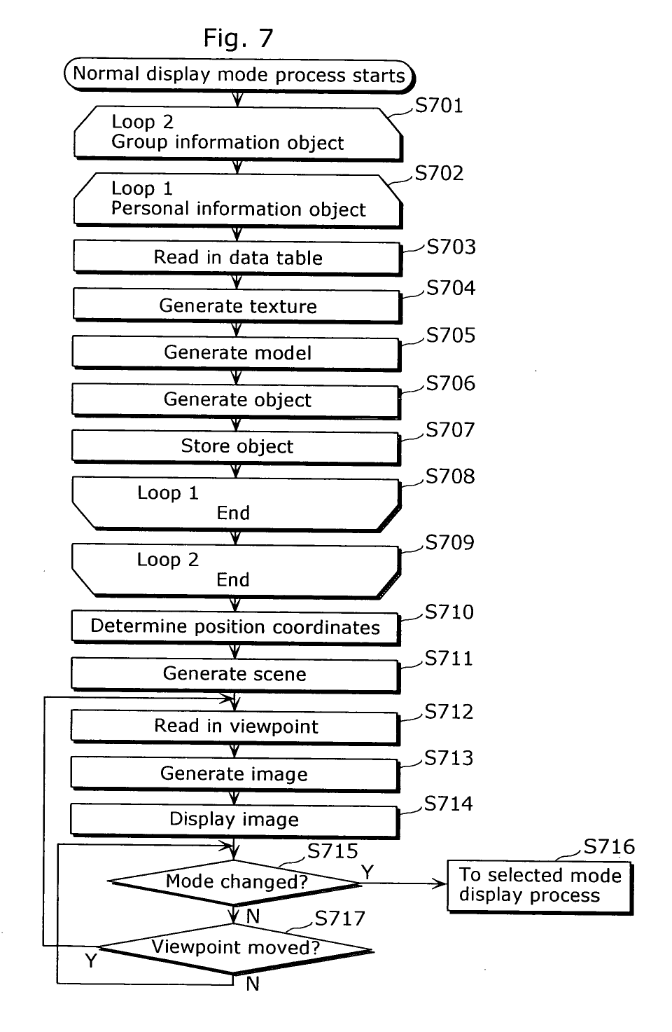

FIG. 7 is a flowchart showing the procedure of displaying a display mode when normal display mode is selected.

First, when the user selects normal display mode either by the mode control unit 310 or the viewpoint moving unit 360, the event control unit 400 instructs the rendering control unit 600 to render personal information objects and group information objects which are required for normal display mode.

Next, the rendering control unit 600 requests the object management unit 200 for the group information objects and the personal information objects. Then, the object management unit 200 requests the information management unit 100 to generate the data table 501 showing personal information and group information.

The information management unit 100 generates the personal ID data table 501 in which each personal information is classified on a group ID basis, and sends the generated data table 501 to the object management unit 200. Note that in order to generate the data table 501, the information management unit 100 obtains personal information from the personal information storage unit 110 and group information from the group information storage unit 120, with reference to the personal information IDs and the group information IDs which it holds, as well as correspondence information about addresses stored in the personal information storage unit 110 and the group information storage unit 120.

The object management unit 200 receives the data table 501, and requests the object generation unit 210 to generate a personal information object and a group information object corresponding respectively to a personal information ID and a group information ID included in the data table 501. In response to this, the object generation unit 210 generates a personal information object and a group information object (S701 and S702).

The object generation unit 210 reads in the data table 501 (S703), and passes, to the texture generation unit 220, the personal name and the group name included respectively in the read-in personal information and group information. The texture generation unit 220 combines, with font image data which it holds in advance, the group name or the personal name, so as to generate a texture image including text for each object (S704).

Subsequently, the model generation unit 230 generates a polygon model for each object (S705). Each polygon model has vertex coordinates of four vertexes in the 3D space and texture coordinates corresponding to the respective vertexes. Note that not only a plate-shaped polygon model with four vertexes but also a primitive and a polygon such as ones in a ball shape and a rectangular shape, may also be used.

The object generation unit 210 generates a personal information object and a group information object by mapping the texture image generated by the texture generation unit 220 on each polygon model generated by the model generation unit 230 (S706).

Each of the generated objects is stored in the object storage unit 240 via the object management unit 200 (S707). Then, Loop 1 for generating personal information objects is terminated when all personal information objects are generated (S708), and Loop 2 for generating group information objects is terminated when all group information objects are generated (S709). Next, the object management unit 200 notifies the rendering control unit 600 that the generation of all objects to be rendered on the screen completes.

Upon the receipt of the above notification from the object management unit 200, the rendering control unit 600 reads the position information of the objects from the position information storage unit 640. Note that as shown in FIG. 6, the position information in normal display mode is represented by 2D arrays of coordinates. Therefore, group information objects are placed in the direction of the x axis 403, and personal information objects belonging to the respective groups are placed under the corresponding group information objects in the direction of the y axis direction 404. Subsequently, the rendering control unit 600 passes the position information and all the objects obtained from the object management unit 200 to the scene generation unit 610.

The scene generation unit 610 determines the position coordinates of each object in the 3D space in the following manner, based on the position information (S710):

(1) multiply the group ID of each object by the first element in the corresponding array in the position information;

(2) multiply (1) by the width of the polygon model of each object (the length in the x axis direction);

(3) the value determined in (2) serves as an x coordinate of the reference vertex of the polygon model of each object;

(4) multiply the personal ID of each object by the second element in the corresponding array in the position information;

(5) multiply (4) by the height of the polygon model of each object (the length in the y axis direction). Note, however, that the value in (4) is “0” in the case of a group information object; and

(6) the value determined in (5) serves as an y coordinate of the reference vertex of the polygon model of each object.

The position coordinates of all the personal information objects and the group information objects are determined by carrying out the steps (1)˜(6) for each of the objects. Subsequently, each object is placed in the 2D space using this position information. As described above, compared with the case where coordinates themselves are retained as data, it becomes easier to make a change in the position information by determining position coordinates by the use of ID information unique to each data.

When the scene generation unit 610 finishes placing all the group information objects and personal information objects, and generates a scene (S711), the image generation unit 620 reads in the viewpoint from the viewpoint coordinates passed by the viewpoint control unit 370 (S712), calculates how the object looks in the 3D space from such viewpoint, and generates an image (S713). Then, by outputting such generated image as image information to the display unit 630, the image is displayed on the screen of the mobile terminal device (S714). In the above manner, normal display mode as shown in FIG. 4 is displayed on the screen.

Next, it is checked whether the user of the mobile terminal device has changed display modes using the mode selection unit 300 or not (S715). The mode display processing is performed when the user has changed display modes (S716), whereas it is further checked whether there is any input from the viewpoint moving unit 360 or not, when the user has not changed display modes (S717). Step S712 and the subsequent steps are repeated when there is an input from the viewpoint moving unit 360, whereas step S714 and the subsequent steps are carried out when the viewpoint has not been moved.

Next, oblique display mode is explained.

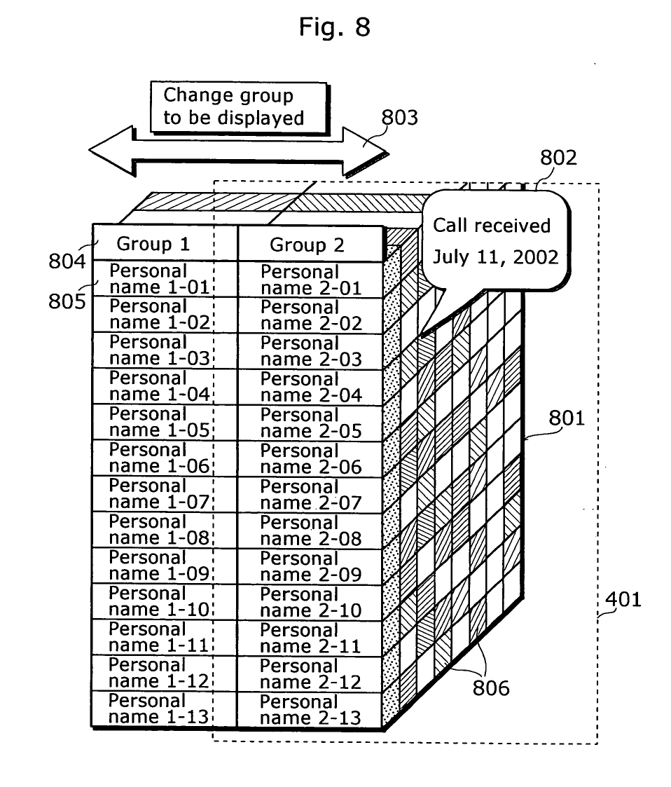

FIG. 8 is a diagram showing an example of oblique display mode displayed on the screen 401 of the mobile terminal device, when the user selects oblique display mode.

When the user selects oblique display mode using the viewpoint moving unit 360 or the mode selection unit 300, an image to be displayed is an oblique view seen from the viewpoint located to the right of a 3D object 801. In FIG. 8, the 3D object 801 is made up of a plurality of group information objects 804 of the groups the user belongs to, personal information objects 805 showing the names of persons belonging to such groups, and various history information objects 806 which are placed in the direction of depth on a person-by-person basis. Furthermore, a history information caption object 802 showing “Call received” and “Jul. 11, 2002” which is history information included in one of the history information objects 806.

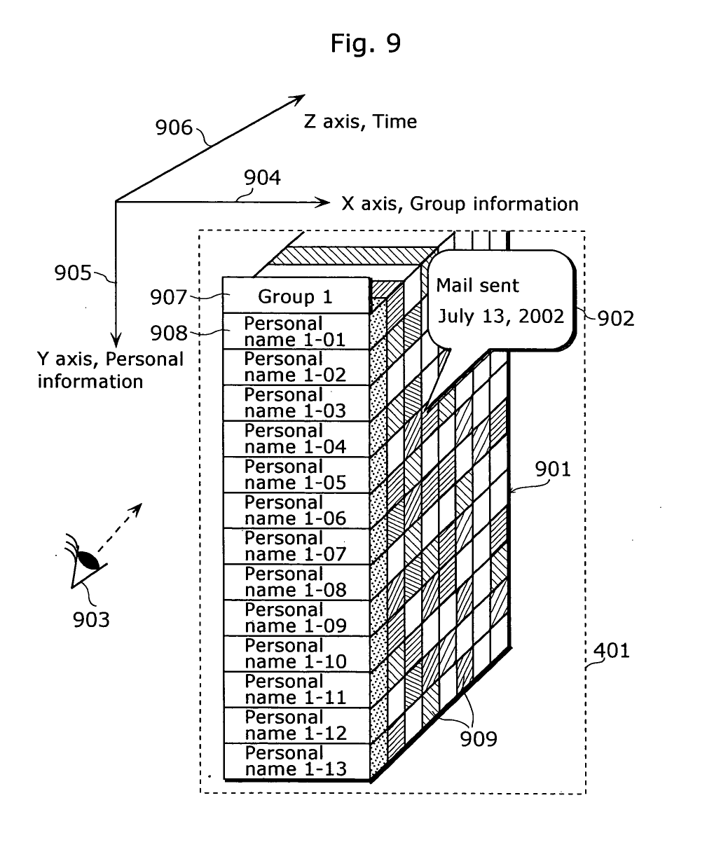

Using the viewpoint moving unit 360, the user can display a desired group information object 804 on the screen 401 by moving the 3D object 801 in parallel, in either the x or y axis direction pointed by an arrow 803. Then, by selecting such desired group information object 804 via the cursor key input unit 320 and the like, the user can have oblique display mode corresponding to one group information, as shown in FIG. 9.

FIG. 9 is a diagram showing an example of oblique display mode shown on the screen 401 of the mobile terminal device, when the user selects oblique display mode.

A 3D object 901 is made up of a group information object 907, personal information objects 908 belonging to such group which are placed in the direction of a y axis 905, and history information objects 909 which are placed in the direction of a z axis 906 and which indicate communication history information of each of the personal names.

Note that the history information objects 909 are usually categorized using different colors according to the user's preference. For example, “Mail sent” is colored in blue, “Mail received” in yellow, “Call made” in red, and “Call received” in green. Note that in FIG. 9, the types of the history information objects 909 are distinguished by using different sloped lines.

When the cursor is placed over a history information object 909, a history information caption object 902 showing the details as well as the date and time of its history information are automatically displayed on the screen 401.

Note that in FIG. 9, the group information object 907 is displayed in 2D, but it may also be a 3D object. Furthermore, it is also possible to place objects showing dates and times on a monthly or daily basis in the direction of z axis, for example, so as to visualize the relationship between the dates and times and history information.

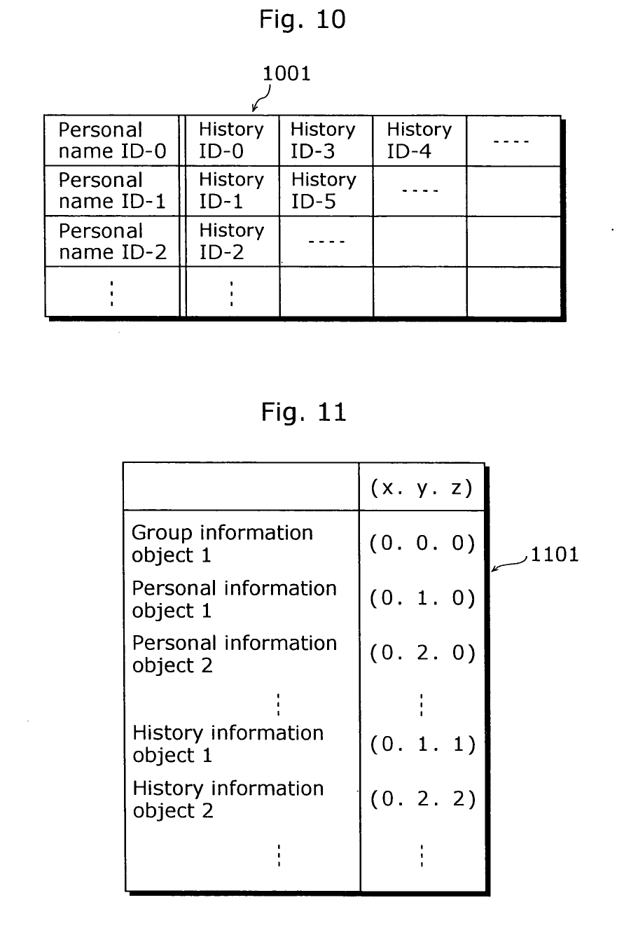

FIG. 10 is a diagram showing an example of a history ID data table 1001, generated by the information management unit 100, in which history IDs are classified on a personal name ID basis.

Upon the receipt of a request for personal information and history information from the object management unit 200, the information management unit 100 generates the data table 1001 that shows history IDs indicating histories of each personal name ID, with reference to personal name IDs and history IDs which it manages, as well as the personal information and the history information stored respectively in the personal information storage unit 110 and the history information storage unit 130. Then, the information management unit 100 sends the generated data table 1001 to the object management unit 200.

For example, the first row in FIG. 10 indicates that Personal name ID-0 has history information of History ID-0, History ID-3, History ID-4, . . . .

FIG. 11 is a diagram showing an example of a position information table 1101 which shows the position of personal information objects, group information objects, and history information objects in oblique display mode.

Since a 3D object is displayed on the screen in oblique display mode, the position of each object in the 3D space is determined when each object's position information in the directions of x axis, y axis, and x axis are determined. For example, the fist row in the position information table 1101 indicates that the position information of Group information object 1 is (0, 0, 0).

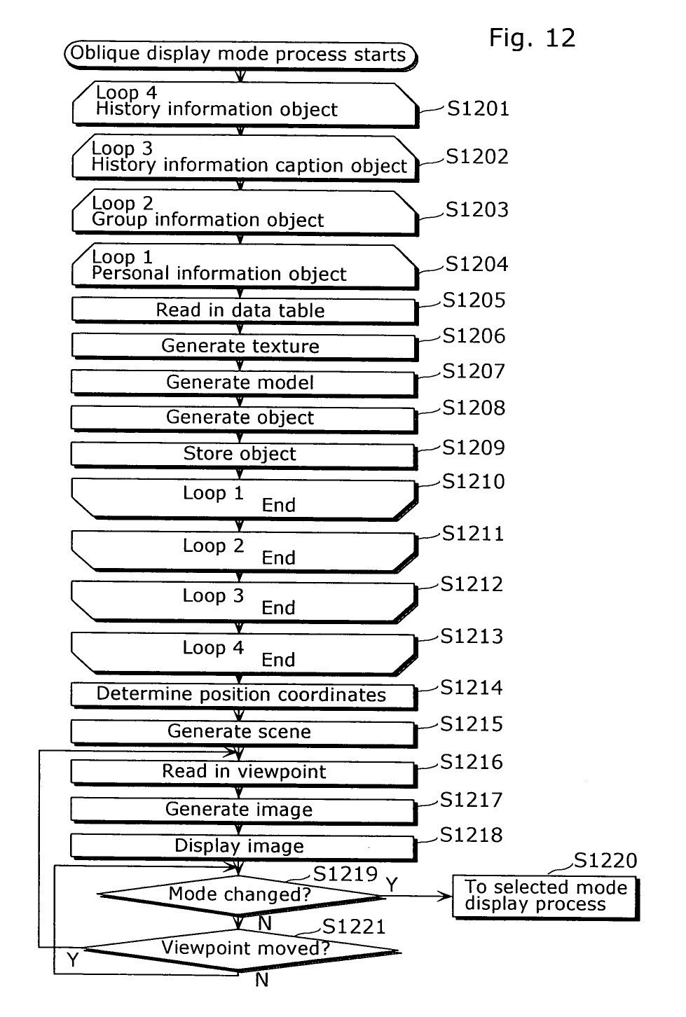

FIG. 12 is a flowchart showing the procedure of displaying a display mode when oblique display mode is selected.

First, when the user selects oblique display mode, an image in which the 3D object 801 is viewed from the right is displayed on the screen 401. When oblique display mode is selected, the event control unit 400 instructs the rendering control unit 600 to render objects required for oblique display mode.

Next, the rendering control unit 600 requests the object management unit 200 for the required objects, as in the case of normal display mode. In oblique display mode, however, in addition to group information objects and personal information objects to be generated in normal display mode, the rendering control unit 600 requests for history information objects and history information caption objects. Subsequently, the object management unit 200 requests the information management unit 100 to generate the history information data table 1101.

The information management unit 100 generates the history ID data table 1101 in which history information is classified on a personal name ID basis, and sends the generated data table 1101 to the object management unit 200.

The object management unit 200 requests the object generation unit 210 to generate a history information object and a is history information caption object corresponding to IDs included in the data table 1101 (S1201 and S1202). In response to this, the object generation unit 210 reads in the data table 1101 (S1205), as in the case of a group information object (S1203) and a personal information object (S1204), and passes the process ID and the time of the obtained history information to the texture generation unit 220.

The texture generation unit 220 includes inside it (i) history information caption texture images describing “Mail sent”, “Mail received”, “Call made” and “Call received” which indicate processes corresponding to the respective process IDs and (ii) surface texture images which represent the surface textures (e.g. color and pattern) of the polygon models of history information objects and which correspond to the respective process IDs. Moreover, the texture generation unit 220 combines, with the time and font image data which it holds inside it, the texture image shown in S704, so as to generate a time texture image showing the time (S1206). Subsequently, the model generation unit 230 generates a polygon model for each object (S1207).

Next, the object generation unit 210 generates the following objects in addition to the objects to be generated in step S706 (S1208): (i) a history information object from a generated surface texture image, the corresponding polygon model, and the obtained history information and (ii) a history information caption object from the history information, a history information caption texture image, a time texture image, and the corresponding polygon model.

Each of the generated objects is stored in the object storage unit 240 via the object management unit 200 (S1209). Then, Loop 1 for generating personal information objects is terminated when all personal information objects are generated (S1210), Loop 2 for generating group information objects is terminated when all group information objects are generated (S1211), Loop 3 for generating history information caption objects is terminated when all history information caption objects are generated (S1212), and Loop 4 for generating history information objects is terminated when all history information objects are generated (S1213). Next, the object management unit 200 notifies the rendering control unit 600 that the generation of all objects to be rendered on the screen completes.

In oblique display mode, as in the case of normal display mode, the rendering control unit 600 reads the position information of each object from the position information storage unit 640, and determines the position coordinates of each object, when receiving the above notification from the object management unit 200. Note that this position information indicates an arrangement of objects in the 3D space in which group information objects are placed in the direction of an x axis 904, personal information objects belonging to the respective groups in the direction of a y axis 905, history information objects belonging to each personal information in the direction of a z axis 906 in time order, as shown in FIG. 9. Subsequently, the rendering control unit 600 passes the position information and all the objects obtained from the object management unit 200 to the scene generation unit 610.

The scene generation unit 610 determines the position coordinates of the group information objects and the personal information objects in the 3D space, based on their position information in the 3D space, as in the case of step 710 for normal display mode. As for the history information objects, the scene generation unit 610 determines the position coordinates of each object in the following manner (S1214):

(1) multiply the group ID of personal information with the same personal ID as that of the history information by the first element in the corresponding array in the position information;

(2) multiply (1) by the width of the polygon model of each history information object;

(3) the value determined in (2) serves as an x coordinate of the reference vertex of the polygon model of each history information object;

(4) multiply the personal ID of each history information object by the second element in the corresponding array in the position information;

(5) multiply (4) by the height of the polygon model of each history information object;

(6) the value determined in (5) serves as a y coordinate of the reference vertex of the polygon model of each history information object;

(7) multiply the history ID of each history information object by the third element in the corresponding array in the position information;

(8) multiply (7) by the depth of the polygon model of each history information object; and

(9) the value determined in (8) serves as a z coordinate of the reference vertex of the polygon model of each history information object.

The position coordinates of all the history information objects are determined by carrying out all the steps (1)˜(9) for each of the objects. Accordingly, each object is placed in the 3D space according to such position coordinates.

The scene generation unit 610 finishes placing all the group information objects, personal information objects, and history information objects, and generates a scene (S1215). Then, the image generation unit 620 reads in the viewpoint passed by the viewpoint control unit 370 via the rendering control unit 600 (S1216), and calculates how the 3D object looks in the 3D space from such viewpoint, and generates an image (S1217). Then, by outputting such generated image as image information to the display unit 630, the image is displayed on the screen of the mobile terminal device (51218). Note that when oblique display mode is selected, the viewpoint is set to the default position as in the case of normal display mode.

Next, it is checked whether the user of the mobile terminal device has changed display modes using the mode selection unit 300 or not (S1219). The mode display processing is performed when the user has changed display modes (S1220), whereas it is further checked whether there is any input from the viewpoint moving unit 360 or not when the user has not changed the display modes (S1221). Step S1216 and the subsequent steps are repeated when there is an input from the viewpoint moving unit 360, whereas step S1218 and the subsequent steps are carried out when the viewpoint has not been moved.

Next, an explanation is given of a method of selecting history information in oblique display mode. As in the case of normal display mode, the scene generation unit 610 places the cursor object at the position indicated by the cursor coordinates in the 3D space. In oblique display mode, when the cursor is moved by the cursor key input unit 320, the respective movements of the cursor in up, down, right and left directions indicate the movements in directions of the negative y axis, positive y axis, negative x axis, and positive x axis, respectively, when no person is determined by the decision key control unit 350, as in the case of normal display mode. When the user determines one person via the decision key input unit 340, the respective movements of the cursor in right and left directions respectively indicate the movements in directions of the negative z axis and positive z axis in the 3D space, and the cursor moves in parallel with the arrangement of the history information objects of the above-determined person.

Then, when the user places the cursor on the desired history information by moving the cursor key toward right or left, the rendering unit 600, as in the case of oblique display mode shown in FIG. 9, automatically displays the history information caption object 902 to which the width of the polygon model of a caption object corresponding to the history information object selected by the cursor is added in the directions of the x and y planes. The user can know the details of this history information by selecting a desired history information object 909 via the decision key input unit 340.

Next, personal information display mode is explained.

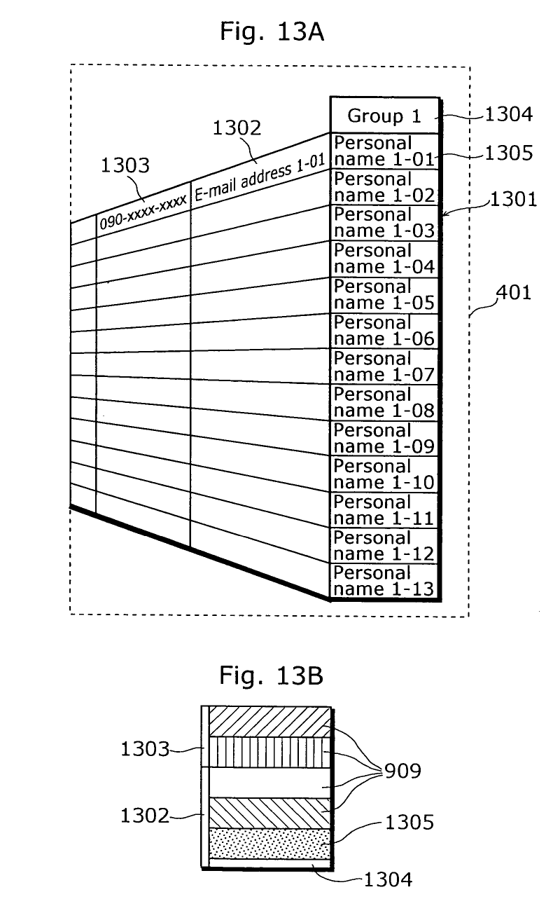

FIG. 13A is a diagram showing an example of personal information display mode, and FIG. 13B is a diagram showing a 3D object 1301 viewed from the top.

As shown in FIG. 13A, on the 3D object 1301, a group information object 1304 is placed in the x axis direction and personal information objects 1305 belonging to such group are placed in the direction of the z axis, as in the case of oblique display mode. Furthermore, personal information element objects 1302, 1303 and the like showing the details of personal information, that is, an e-mail addresses and a telephone number, are placed in the z axis direction, in association with the corresponding personal information object 1305. Various personal information such as address and birthday can be shown as the personal information element objects 1302, 1303 and the like.

The top view shown in FIG. 13B illustrates the positional relationship in the 3D space among the group information object 1304, the personal information objects 1305, the history information objects 909, and the personal information element objects 1302 and 1303. As shown in FIG. 13B, the personal information element objects 1302 and the like are mapped on one side of the history information objects 909 as 2D texture images. Note that in FIG. 13B, the group information object 1304 and personal information element objects 1302 and 1303 are illustrated in 3D for explanation purposes, but these objects are assumed to be 2D texture images.

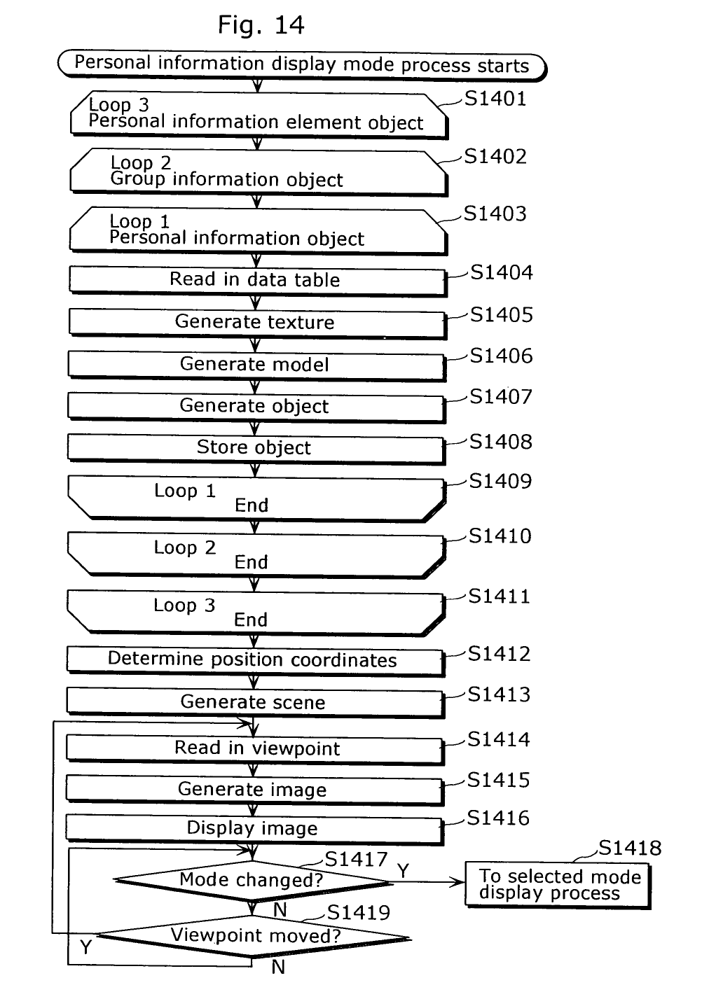

FIG. 14 is a flowchart showing the procedure of displaying a display mode when personal information display mode is selected.

First, when the user of the mobile terminal device selects personal information display mode, the event control unit 400 instructs the rendering control unit 600 to render objects required for personal information display mode. In so doing, the rendering control unit 600 requests the object management unit 200 to generate personal information element objects, in addition to group information objects and the personal information objects to be generated for normal display mode. Subsequently, the object management unit 200 requests the information management unit 100 to generate a personal information element data table. Personal information element here is an e-mail address, a telephone number, an address, and the like. Note that a detailed explanation of the generation of group information objects and personal information objects (S1402 and S1403) is omitted, since they are explained in FIG. 7. The information management unit 100 generates the personal information element data table in which history information is classified on a personal name ID basis, and sends the generated data table to the object management unit 200.

Next, the object management unit 200 requests the object generation unit 210 to generate a personal information element object corresponding to each of the IDs included in the data table (S1401). In response to this, the object generation unit 210 reads in the data table as in the case of the group information objects (S1402) and the personal information objects (51403), and passes the personal information elements obtained from the data table to the texture generation unit 220.

The object generation unit 210 generates a personal information object, a group information object, and a personal information element object. In the case of a personal information object, the texture generation unit 220 combines, with font image data which it holds in advance, the corresponding personal name in the personal information, so as to generate a texture image including text. In the case of a personal information element object, however, the texture generation unit 220 generates a texture image including text, by combining an e-mail address, a telephone number, an address, or a memo in the personal information with font image data (S1405).

Subsequently, the model generation unit 230 generates a polygon model (S1406), and the object generation unit 210 generates a personal information element object by mapping the texture image on such polygon model (S1407). Each of the generated objects is stored in the object storage unit 240 via the object management unit 200 (S1408). Then, Loop 1 for generating personal information objects is terminated when all personal information objects are generated (S1409), Loop 2 for generating group information objects is terminated when all group information objects are generated (S1410), and Loop 3 for generating personal information element objects is terminated when all group information objects are generated (S1411). Next, the object management unit 200 notifies the rendering control unit 600 that the generation of all objects to be rendered on the screen completes.

Upon the receipt of the above notification from the object management unit 200, the rendering control unit 600 reads, from the position information storage unit 640, the position information indicating where each type of objects shall be placed. The position information indicates a 3D arrangement of objects in which the group information object is placed in the direction of the x axis, the personal information objects belonging to the group are placed under the group information object in the direction of the y axis, and the personal information element objects belonging to each personal information are placed in the direction of z axis, as shown in the 3D object 1301 in FIGS. 13A. Subsequently, the rendering control unit 600 passes the position information and all the objects obtained from the object management unit 200 to the scene generation unit 610.

The scene generation unit 610 determines the position coordinates of each personal information object and group information object, as in the case of step S710 for normal display mode. As for the personal information element objects, the position coordinates of each object are determined in the following manner (S1412):

(1) multiply the group ID in the personal information by the first element in the corresponding array in the position information;

(2) multiply (1) by the width of the polygon model of each personal information element object;

(3) the value determined in (2) serves as an x coordinate of the reference vertex of the polygon model of each personal information element object;

(4) multiply the personal ID in the personal information by the second element in the corresponding array in the position information;

(5) multiply (4) by the height of the polygon model of each personal information element object;

(6) the value determined in (5) serves as a y coordinate of the reference vertex of the polygon model of each personal information element object;

(7) assign an ID to each personal information element, i.e. e-mail address, telephone number, address and memo in this order;

(8) multiply each of the IDs assigned in (7) by the third element in the corresponding array in the position information;

(9) multiply (8) by the depth of the polygon model of each personal information element object; and

(10) the value determined in (9) serves as a z coordinate of the reference vertex of the polygon model of each personal information element object.

The position coordinates of all the personal information element objects are determined by carrying out all the steps (1)˜(10) for each of the objects. Accordingly, each personal information element object will be placed in the 3D space.

When the scene generation unit 610 finishes placing all the group information objects, personal information objects and personal information element objects, and generates a scene (S1413), the image generation unit 620 reads in the viewpoint from the viewpoint coordinates passed by the viewpoint control unit 370 via the rendering control unit 600 (S1414), calculates how the object looks in the 3D space from such viewpoint, and generates an image (S1415). Then, by outputting such generated image as image information to the display unit 630, the image is displayed on the screen of the mobile terminal device (S1416). In the above manner, personal information display mode as shown in FIG. 13A is displayed on the screen.

Next, it is checked whether or not the user of the mobile terminal device has changed display modes using the mode selection unit 300 (S1417). The mode display processing is performed when the user has changed display modes (S1418), whereas it is further checked whether or not there is any input from the viewpoint moving unit 360, when the user has not changed the display modes (S1419). Step S1414 and the subsequent steps are repeated when there is an input from the viewpoint moving unit 360, whereas step S1416 and the subsequent steps are carried out when the viewpoint has not been moved.

Note that in personal information display mode, a method of selecting a personal information element object is the same as that of selecting history information in oblique display mode. Therefore, when one personal information element object is determined via the decision key input unit 340, the event control unit 400 passes the selected personal information element to the personal information output unit 330. For example, when the user selects the e-mail address of a person whose name is Mr. A, a screen for sending a mail is displayed. Similarly, when the user selects the telephone number of Mr. A, a call is made to A or a screen for making a phone call is displayed.

Next, immersive information display mode is explained.

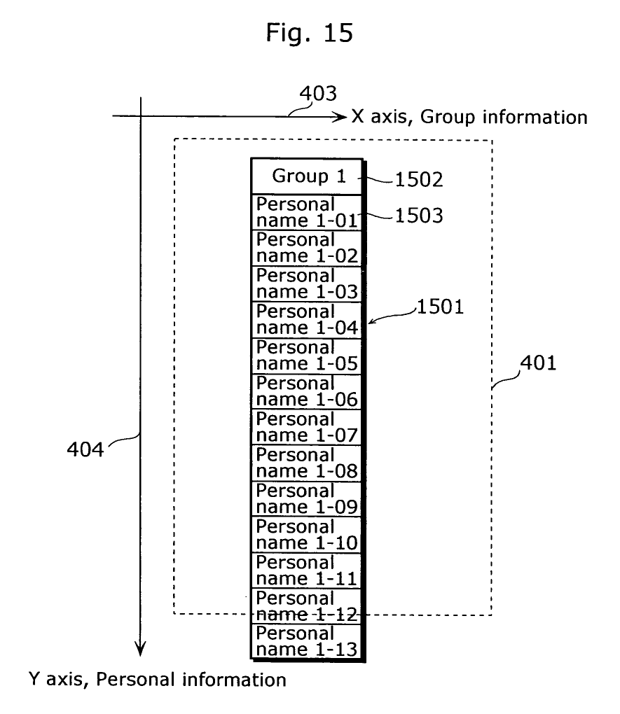

FIG. 15 is a diagram showing an example of a selection screen 1501 shown on the screen 401 of the mobile terminal device before the user selects immersive information display mode. On the selection screen 1501 before immersive information display mode is selected, a group information object 1502 is placed in the direction of the x axis 403 and displayed in 2D, and personal information objects 1503 belonging to such group are placed in the direction of the y axis 404 and displayed in 2D, as in the case of normal display mode.

Note that when the selection screen displayed before immersive information display mode is selected, the viewpoint control unit 370 sets the viewpoint to the default position. The default position of the viewpoint in oblique display mode is a position from which the 3D object 901 is viewed at an oblique angle as shown in FIG. 9. In immersive information display mode, however, the default viewpoint position is one from which an image is viewed from the front, as in the case of normal display mode.

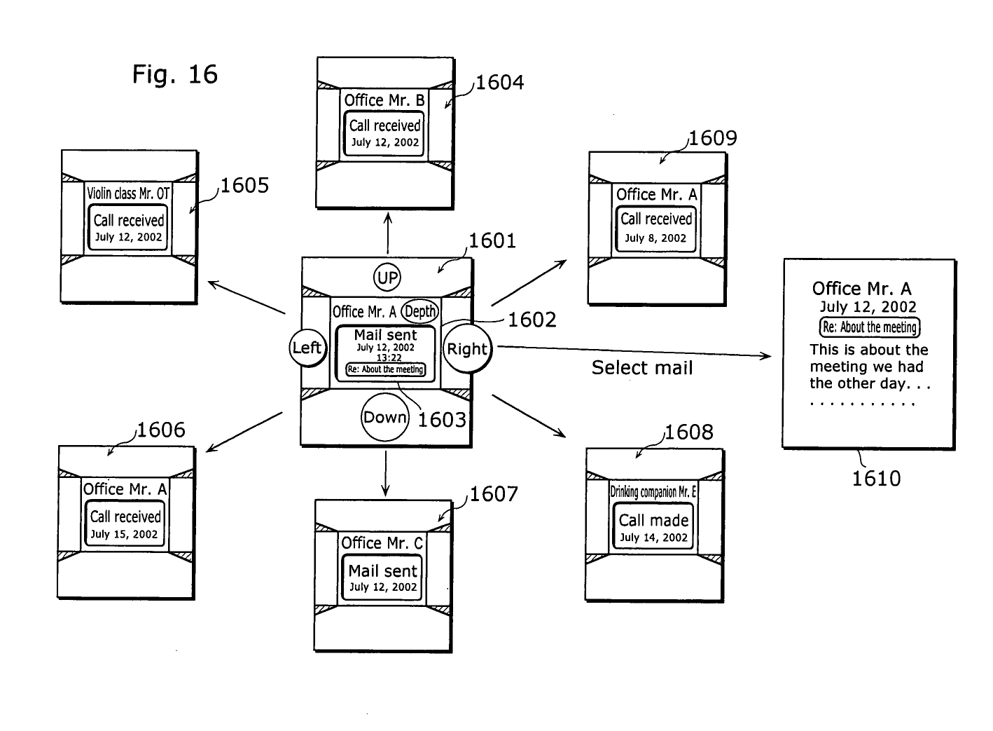

FIG. 16 is a diagram showing a display example of immersive information display mode to be displayed when the user selects one of the personal information objects 1503 in the selection screen shown before immersive information display mode is selected, as well as showing a display example when the viewpoint moves inside the history information objects in x, y, and z directions.

First, on the selection screen 1501 shown in FIG. 15, the user selects one of the personal information objects 1503 that includes required information. Upon this selection, the selection screen 1501 changes to an immersive information display screen 1601 on which a history information caption object 1603 of the above-selected person is shown on a square space. This history information caption object 1603 is displayed according to the temporal flow, that is, the latest information is usually displayed on the screen. Note that the history information caption object 1603 shown on this immersive information display screen 1601 describes a group “Office”, a personal name “Mr. A”, and the date and time “Jul. 12, 2002”.

In the present invention, the user can move from the immersive information display screen 1601 to another immersive information display screen 1604 and the like by moving the viewpoint in a three dimensional manner using the viewpoint moving unit 360. Stated another way, the user can move through the history information objects that make up the 3D object.

In the case where the user moves the viewpoint up or down via the viewpoint moving unit 360, such user can move to another history information object of another person belonging to the same group as the one shown on the immersive information display screen 1601. For example, when the user moves the viewpoint upward, the immersive information display screen 1601 changes to the immersive information display screen 1604 of the same day (“Jul. 12, 2002”) of another person (Mr. B) belonging to the same group (“Office”), and the history information of such person is displayed. Similarly, an immersive information display screen 1607 to be shown when the user moves the viewpoint downward is the history information of the same day of another person belonging to the same group as the one shown on the immersive information display screen 1601.

In the case where the user moves the viewpoint toward right or left via the viewpoint moving unit 360, the user can move to history information of the same day of another person belonging to a group different from the one shown on the immersive information display screen 1601. For example, when the user moves the viewpoint leftward, the immersive information display screen 1601 changes to an immersive information display screen 1605 of the same day (“Jul. 12, 2002”) of another person (Mr. OT) belonging to a different group (“Violin class”), and the history information of such person is displayed. Similarly, an immersive information display screen 1608 to be shown when the user moves the viewpoint rightward is history information of the same day of another person belonging to a group different from the one shown on the immersive information display screen 1601.

In the case where the user moves the viewpoint in the z axis direction via the viewpoint moving unit 360, the user can move to history information of another date of the same person belonging to the same group as the one shown on the immersive information display screen 1601. For example, an immersive information display screen 1609 to be shown when the user moves the viewpoint to the positive z axis direction shows older history information (“Jul. 08, 2002”) of the same person (“Mr. A”) belonging to the same group (“Office”) as the one shown on the immersive information display screen 1601. Similarly, an immersive information display screen 1606 to be shown when the user moves the viewpoint to the negative z axis direction shows newer history information of the same person belonging to the same group as the one shown in the immersive information display screen 1601.

When referring to the details of history information in all immersive information display screens including 601, the user shall select a history information caption object 1603 using the decision key input unit 340 and the like. For example, when the user selects the history information caption object 1603 displayed on the immersive information display screen 1601 using the cursor key input unit 320 and the decision key input unit 340, a screen 1610 is selected showing the details of the corresponding history selected with reference to a database or the like that stores history information.

As described above, the mobile terminal device according to the present invention enables the user to make a reference to desired history information just like moving from one history information object to another constituting the 3D object just by moving the viewpoint in the 3D space in immersive information display mode. Accordingly, it becomes possible for such user to search for group information, personal information, and time information in association with history information, and therefore to have a grasp of information from a chronological standpoint.

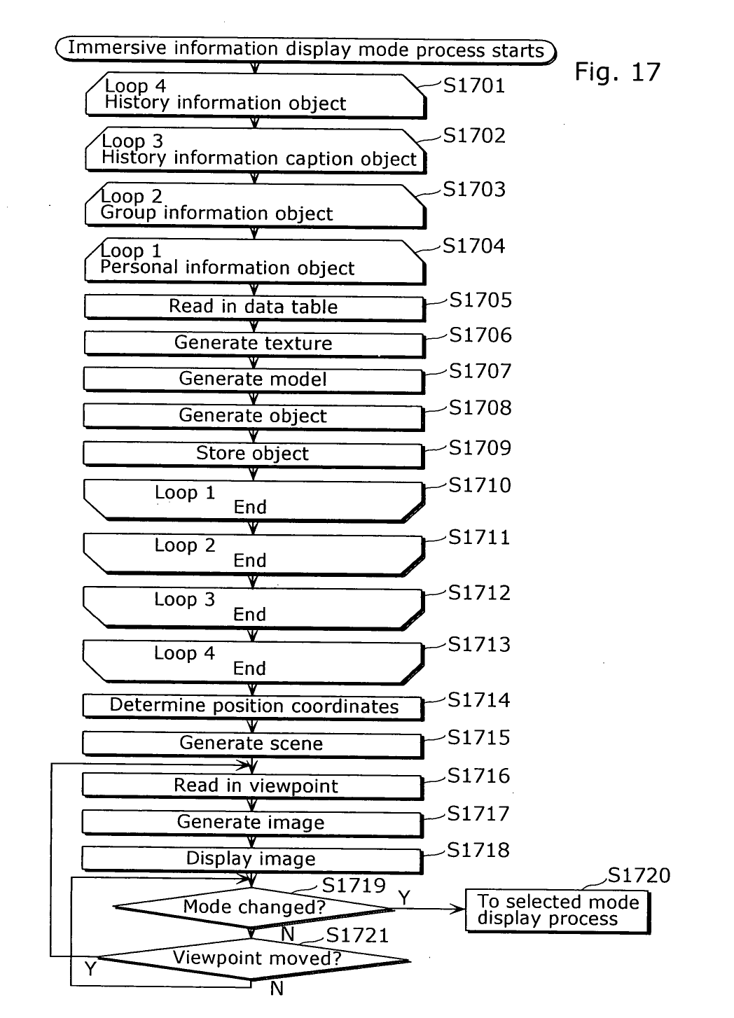

FIG. 17 is a flowchart showing the procedure of displaying a display mode when immersive information display mode is selected. Note that a concrete explanation is omitted for the same parts as those of oblique display mode shown in FIG. 12.

First, when the user selects immersive information display mode via the mode selection unit 300, the information management unit 100 and the object management unit 200 generate a group information object, a personal information object, a history information object, and a history information caption object, as in the case of oblique display mode (S1701˜S1704). Note that procedure from steps S1705˜S1713 are the same as that from steps S1405˜S1413 shown in FIG. 12.

As in the case of oblique display mode, upon the receipt of a notification from the object management unit 200 that all objects to be rendered have been generated, the rendering control unit 600 reads, from the position information storage unit 640, the position information indicating how each type of the objects shall be placed, and determines the position coordinates of each object (S1714). The position of each object is the same as the one in the case of oblique display mode. Furthermore, processes for the subsequent steps S1715˜S1721 are the same as those of steps S1215˜S1221 in oblique display mode shown in FIG. 12.

Next, an explanation is given of a method of selecting history information in immersive information display mode. As in the case of oblique display mode, the scene generation unit 610 places the cursor object at a position in the 3D space indicated by cursor coordinates. When the cursor is moved by the cursor key input unit 320, the respective movements of the cursor in up, down, right and left directions indicate the movements in directions of the negative y axis, positive y axis, negative x axis, and positive x axis in the 3D space, respectively, if no personal information is determined by the decision key control unit 350. In immersive information display mode, the viewpoint is moved in the positive z axis direction by the zoom-up key input unit in the viewpoint moving unit 360 and in the negative z axis direction by the zoom-down key input unit in the viewpoint moving unit 360. When the user selects one history information via the decision key input unit 340, the event control unit 400 displays the contents of the selected mail, by passing the selected personal information and history information to the personal information output unit 500.

In immersive information display mode, when the viewpoint goes inside a history information object, the rendering control unit 600 requests the object management unit 200 to generate a history information caption object 1603. As in the case of oblique display mode, the object generation unit 210 generates the history information caption object 1603, and places it in a position which is obtained by adding a z coordinate of the reference point of the history information object to the depth of the polygon model of the history information caption object 1603, so that such history information caption object 1603 can be placed inside the history information object. Note, however, that the depth of the history information caption object 1603 shall be smaller than the history information object.

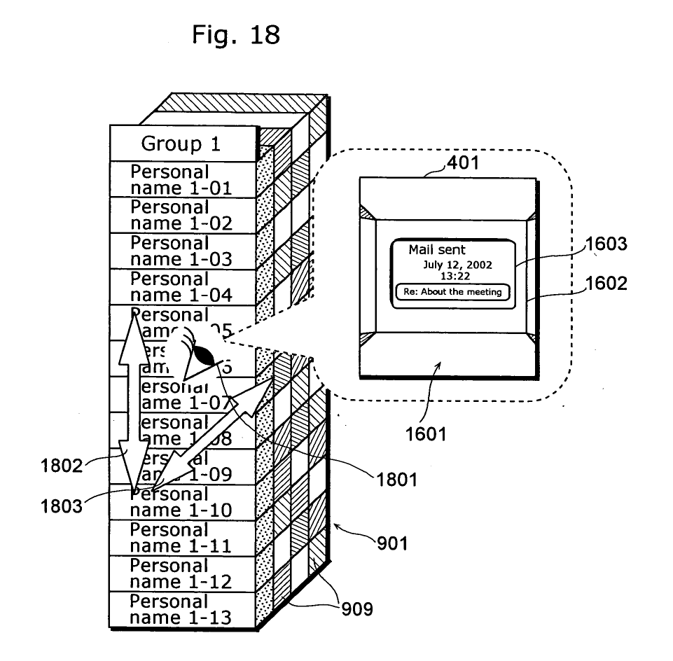

FIG. 18 is a diagram for explaining a difference between the respective viewpoint positions in oblique display mode and immersive information display mode.

When the user of the mobile terminal device moves the viewpoint position 903 shown in FIG. 9 by the viewpoint moving unit 360 closer to the 3D object 1201 and reaches a viewpoint 1801 which is inside a history information object, the immersive information display screen 1601 is shown on the screen 401.

Then, by moving the viewpoint in directions indicated by double-headed arrows 1802 and 1803 via the viewpoint moving unit 360, it becomes possible for the user to refer to desired history information just like moving from one history information object 909 to another history information object 909 which are like rooms constituting the 3D object 901.

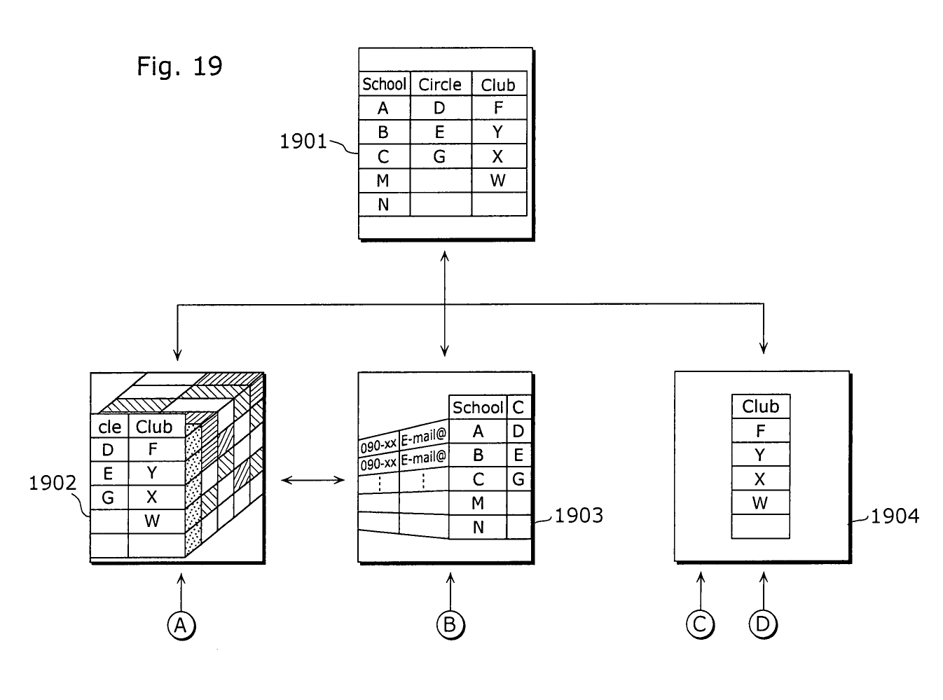

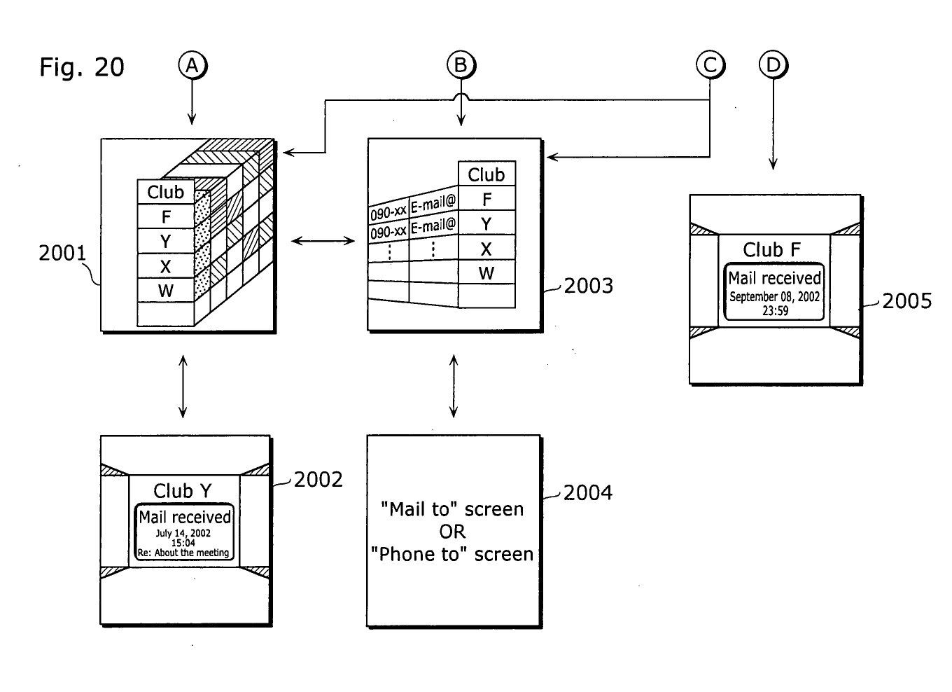

FIGS. 19 and 20 are reference diagrams visualizing changes between normal display mode, oblique display mode, immersive information display mode, and personal information display mode, which are four display modes to be shown on the screen of the mobile terminal device according to the present invention. Note that an explanation is given here on the assumption that As, Bs, Cs, and Ds shown in FIGS. 19 and 20 are linked to each other. Also note that double-headed arrows shown in FIGS. 19 and 20 indicate that two display modes can be switched between them.

Using the mode selection unit 300 or the viewpoint moving unit 360, the user of the mobile terminal device selects whether to move to oblique display mode 1902, the personal information display mode 1903, or immersive information display mode 1904 from normal display mode 1901.

First, in normal display mode 1901, the user can move to the following modes by making an input to the viewpoint moving unit 360: (i) to oblique display mode 1902 by moving the viewpoint toward right; (ii) to personal information display mode 1903 by moving the viewpoint toward left; and (iii) to immersive information display mode 1904 by selecting group information by the cursor without moving the viewpoint. Note that oblique display mode 1902 and personal information display mode 1903 can be switched between them by moving the viewpoint toward right or left via the viewpoint moving unit 360 or by making a mode selection via the mode selection unit 300.

By selecting a desired group information object from among plural group information objects selectable in oblique display mode 1902, the user can move to oblique display mode 2001 in which only the selected group information is displayed from an oblique direction. Similarly, by selecting group information in personal information display mode 1903, the user can move to personal information display mode 2003 in which only the selected group information is displayed. Note that oblique display mode 2001 and personal information display mode 2003 can be switched between them by moving the viewpoint toward right or left via the viewpoint moving unit 360.

Meanwhile, the user can move to immersive information display mode 2002 by selecting history information shown in oblique display mode 2001. Furthermore, by selecting an e-mail address or a telephone number shown in personal information display mode 2003, the user can move to a screen 2004 for sending a mail or making a phone call.

In immersive information display mode 1904, when the user selects one person and moves the viewpoint to the depth direction so as to go inside a history information object, the screen changes to immersive information display mode 2005. Note that it is also conceivable that the user can change to immersive information display mode 2005 by selecting one person or by moving the viewpoint to the depth direction directly from normal display mode 1901. Moreover, it is also possible for the user to change from immersive information display mode 1904 to oblique display mode 2001 or to personal information display mode 2003 by using the mode selection unit 300.

As explained above, the mobile terminal device according to the present invention is capable of displaying an increased amount of information all at once by displaying, on the screen, a 3D object made up of various objects showing personal information and history information, as well as capable of clarifying the relationship between plural pieces of information even on the small screen. Accordingly, it is possible for the present invention to provide mobile terminal devices capable of improving the user convenience at the time of selecting information.

Also, the mobile terminal device according to the present invention is equipped with the viewpoint moving unit 360 and the image generation unit 620 that generates an image according to an input from such viewpoint moving unit 360. This enables the user to display an image of the 3D object on the screen by moving such 3D object in all directions via the viewpoint moving unit 360. Accordingly, such mobile terminal device can display a larger amount of information all at once and clarify the relationship between plural pieces of information even on the small screen. Therefore, the present invention saves the user's trouble of switching screens on an information basis, which is required for displaying data on an exiting mobile terminal device. Thus, the present invention is capable of significantly facilitating user selections of information.

Furthermore, since history information objects are placed in the z axis direction according to the temporal flow utilizing the 3D object, pieces of information are placed in a manner that enables the user to grasp the relationship among such pieces of information more easily. Therefore, it becomes possible to distinctly display a chronological relationship between personal information and history information on the 3D object. Accordingly, the present invention will be able to provide mobile terminal devices capable of displaying images that take into account the convenience of the users.

Moreover, since the user of the mobile terminal device can select a display mode from among display modes such as normal display mode and oblique display mode via the mode selection unit 300 and the viewpoint moving unit 360, it becomes possible for such user to select a desired display mode in order to obtain required information. This further improves the convenience of the user in terms of operationality. Also, the mobile terminal device according to the present invention further has the functionality of automatically changing display modes according a movement of the viewpoint caused by the viewpoint moving unit 360, and therefore is capable of improving the user usability.

What is more, it is possible for the user of the mobile terminal device to move from one history information object to another history information object that constitute the 3D object, so as to refer to desired history information by moving the viewpoint in the 3D space in immersive information display mode. Accordingly, it becomes possible for such user to search for history information in association with group information, personal information, and time information.

It should be understood that the above explanation of the present embodiment is simply an example, and therefore that the present invention is not limited to such explained embodiment and is capable of being employed in its range of application.

What is claimed is:

1. A mobile terminal device that has a database storing a first information list, a second information list and a third information list, comprising:
a scene generation unit operable to generate a 3D object on which the first information list is associated with a direction of a first axis, the second information list is associated with a direction of a second axis, and the third information list is associated with a direction of a third axis, the first to third axes being in a 3D xyz space, the second information list relating to the first information list, and the third information list relating to either the first information list or the second information list; and
a display unit operable to display the generated 3D object on a screen of the mobile terminal device.

2. The mobile terminal device according to claim 1, further comprising:
a viewpoint moving unit operable to move a viewpoint freely according to an input from a user of the mobile terminal device; and
an image generation unit operable to generate an image of the 3D object generated by the scene generation unit, the image being viewed from the moved viewpoint,
wherein the display unit displays the 3D object on the screen of the mobile terminal device according to the image generated by the image generation unit.

3. The mobile terminal device according to claim 1,
wherein the first information list is a personal information list, and
the second information list and the third information list are related information lists that relate to said personal information list.

4. The mobile terminal device according to claim 3,
wherein the related information lists include a group information list and a history information list.

5. The mobile terminal device according to claim 4,
wherein the personal information list includes personal information which is any one of a personal name, an e-mail address, a telephone number, and an address,
the group information list includes any one of group information which is definable by the user of the mobile terminal device and group information which is stored in advance, and
the history information list includes history information which is any one of information about sending of a mail, receiving of a mail, a picture, a schedule, making of a telephone call, and receiving of a telephone call.

6. The mobile terminal device according to claim 1,
wherein the first information list, the second information list, and the third information list are texture-mapped on the 3D object in the first axis direction, the second axis direction, and the third axis direction, respectively.

7. The mobile terminal device according to claim 1, further comprising:
a texture generation unit operable to generate 2D texture images showing items listed on each of the lists stored in the database;
a model generation unit operable to generate polygon models having 2D or 3D space coordinates; and
an object generation unit operable to generate small objects by mapping each of the generated texture images on a surface of or inside each of the polygon models,
wherein the scene generation unit generates the 3D object by laying said small objects on one another in the 3D xyz space.

8. The mobile terminal device according to claim 7, further comprising a cursor key input unit operable to move a position of a cursor displayed on the screen to a position required by the user, according to an instruction from said user; and
a decision key input unit operable to decide one of the small objects on which the cursor is placed,
wherein the display unit displays, on the screen, an enlarged view of the texture image mapped on the surface of or inside the small object decided by the decision key input unit.

9. The mobile terminal device according to claim 8,
wherein the object generation unit generates a history information caption object by mapping, on the surface of one of the 2D polygon models, one of the texture images that shows a detail of history information, and
the display unit displays said history information caption object on the screen as a balloon, the history information caption object corresponding to the small object pointed by the cursor.

10. The mobile terminal device according to claim 7,
wherein each of the small objects is one of the following objects:
(a) a personal information object generated by mapping, on one of the polygon models, one of the texture images that shows a personal name listed on a personal information list that is one of the lists stored in the database;
(b) a group information object generated by mapping, on one of the polygon models, one of the texture images that shows a group name listed on a group information list that is one of the lists stored in the database;
(c) a history information object generated by mapping, on one of the polygon models, one of the texture images t hat is represented by a different color depending on an item listed on a history information list that is one of the lists stored in the database; and
(d) a personal information element object generated by mapping, on one of the polygon models, one of the texture images that shows personal information listed on the personal information list that is one of the lists stored in the database.

11. The mobile terminal device according to one of claims 1 and 2, further comprising a mode selection unit operable to select one of a plurality of display modes for displaying an image of the 3D object viewed from the viewpoint in the 3D xyz space,
wherein the display unit displays the 3D object on the screen according to the display mode which the mode selection unit selects based on an instruction from the user, and
the display modes include at least one of the following display modes: normal display mode for displaying a front view of the 3D object; oblique display mode for displaying an oblique view of the 3D object; and immersive information display mode for displaying an internal view of the 3D object.

12. The mobile terminal device according to claim 11,
wherein the scene generation unit generates an immersive information display object that shows, on the screen, an internal view of a history information object which shows history information and to which a texture image is mapped inside, when the mode selection unit selects the immersive information display mode, and
the display unit displays said immersive information display object on the screen.

13. The mobile terminal device according to claim 12,
wherein the viewpoint moving unit performs processing for moving to an internal view of another history information object adjacent to the history information object displayed on the screen, by seamlessly moving the viewpoint in the directions of the three axes according to an input from the user of the mobile terminal device, and
the display unit displays, on the screen, the immersive information display object that is generated by the scene generation unit after said processing.

14. The mobile terminal device according to claim 11,
wherein the scene generation unit generates a normal display object on which a group information object showing group information is placed in the first axis direction and a personal information object showing a personal name that belongs to said group information object is placed in the second axis direction, when the mode selection unit selects the normal display mode, the normal display object showing the front view of the 3D object, and
the display unit displays said normal display object on the screen.

15. The mobile terminal device according to claim 11,
wherein the scene generation unit generates the 3D object on which the following objects are texture-mapped in the corresponding directions, when the mode selection unit selects the oblique display mode: a group information object that shows group information and is texture-mapped in the first axis direction; a personal information object that shows a personal name belonging to said group information object and is texture-mapped in the second axis direction; a history information object that shows history information and a personal information element object that shows personal information, the history information object and the personal information element object relating to said personal information object and being texture-mapped in the third axis direction,
the viewpoint moving unit performs processing for moving the viewpoint freely according to an input from the user of the mobile terminal device,
the image generation unit generates an image of the oblique view of the generated 3D object, the image being viewed from the moved viewpoint, and
the display unit displays the 3D object on the screen of the mobile terminal device according to the image generated by the image generation unit.

16. The mobile terminal device according to claim 11, further comprising a mode change unit operable to change a display mode shown on the screen of the mobile terminal device to another display mode, according to the movement made by the viewpoint moving unit,
wherein the display unit displays the 3D object on the screen according to the change made by the mode change unit.

17. An image display method of displaying an image on a screen of a mobile terminal device that has a database storing a first information list, a second information list, and a third information list, the image display method comprising:
a scene generation step of generating a 3D object on which the first information list is associated with a direction of a first axis, the second information list is associated with a direction of a second axis, and the third information list is associated with a direction of a third axis, the first to third axes being in a 3D xyz space, the second information list relating to the first information list, and the third information list relating to either the first information list or the second information list; and
a display step of displaying the generated 3D object on the screen of the mobile terminal device.

18. The image display method according to claim 17, further comprising:
a viewpoint moving step of moving a viewpoint freely according to an input from a user of the mobile terminal device; and
an image generation step of generating an image of the 3D object generated in the scene generation step, the image being viewed from the moved viewpoint,
wherein, in the display step, the 3D object is displayed on the screen of the mobile terminal device according to the image generated in the image generation step.

19. The image display method according to claim 17, further comprising:
a texture generation step of generating 2D texture images showing items listed on each of the lists stored in the database;
a model generation step of generating polygon models having 2D or 3D space coordinates; and
an object generation step of generating small objects by mapping each of the generated texture images on a surface of or inside each of the polygon models,
wherein, in the scene generation step, the 3D object is generated by laying said small objects on one another in the 3D xyz space.

20. The image display method according to claim 17, further comprising a mode selection step of selecting one of a plurality of display modes for displaying the image of the 3D object viewed from the viewpoint in the 3D xyz space,
wherein, in the display step, the 3D object is displayed on the screen according to the display mode selected in the mode selection step based on an instruction from the user, and
the display modes include at least one of the following display modes: normal display mode for displaying a front view of the 3D object; oblique display mode for displaying an oblique view of the 3D object; and immersive information display mode for displaying an internal view of the 3D object.

21. A program for a mobile terminal device that has a database storing a first information list, a second information list, and a third information list, the program comprising following steps:
a scene generation step of generating a 3D object on which the first information list is associated with a direction of a first axis, the second information list is associated with a direction of a second axis, and the third information list is associated with a direction of a third axis, the first to third axes being in a 3D xyz space, the second information list relating to the first information list, and the third information list relating to either the first information list or the second information list; and
a display step of displaying the generated 3D object on the screen of the mobile terminal device.

22. The program according to claim 21, further comprising:
a viewpoint moving step of moving a viewpoint freely according to an input from a user of the mobile terminal device; and
an image generation step of generating an image of the 3D object generated in the scene generation step, the image being viewed from the moved viewpoint,
wherein, in the display step, the 3D object is displayed on the screen of the mobile terminal device according to the image generated in the image generation step.

23. The program according to claim 21, further comprising:
a texture generation step of generating 2D texture images showing items listed on each of the lists stored in the database;
a model generation step of generating polygon models having 2D or 3D space coordinates; and
an object generation step of generating small objects by mapping each of the generated texture images on a surface of or inside each of the polygon models,
wherein, in the scene generation step, the 3D object is generated by laying said small objects on one another in the 3D xyz space.

24. The program according to claim 21, further comprising a mode selection step of selecting one of a plurality of display modes for displaying the image of the 3D object viewed from the viewpoint in the 3D xyz space,
wherein, in the display step, the 3D object is displayed on the screen according to the display mode selected in the mode selection step based on an instruction from the user, and
the display modes include at least one of the following display modes: normal display mode for displaying a front view of the 3D object; oblique display mode for displaying an oblique view of the 3D object; and immersive information display mode for displaying an internal view of the 3D object.
